(19) United States
(12) Patent Application Publication
(10) Pub. No.: US 2016/0348486 A1
(43) Pub. Date: Dec. 1, 2016

(54) METHOD FOR REDUCING SALT WATER INTRUSION INTO AN AQUIFER

(71) Applicant: Edison International, Rosemead, CA (US)

(72) Inventor: Daniel Stephen Chase, Glendale, CA (US)

(21) Appl. No.: 15/066,268

(22) Filed: Mar. 10, 2016

Related U.S. Application Data
(63) Continuation-in-part of application No. 14/843,189, filed on Sep. 2, 2015.
(60) Provisional application No. 62/167,468, filed on May 28, 2015.

(51) Int. Cl. E21B 43/12; E21B 49/08; E21B 41/00; C02F 1/44

(52) U.S. Cl. CPC E21B 43/121; C02F 1/441; E21B 49/08; E21B 41/00; C02F 2103/06

(57) ABSTRACT

A control method for controlling the intrusion of dissolved solids into a fresh water aquifer located proximate to an ocean includes the steps of: a) frequently measuring the TDS content at a control location, such frequent measuring of TDS content at the control location being conducted at least about once per calendar quarter, the frequent measuring of TDS content at the control location providing a plurality of control location TDS content values; b) comparing one or more of the plurality of control location TDS content values to a predetermined TDS control range; and c) adjusting the TDS content at the control location to within the predetermined TDS control range by one or more control measures.

### CROSS-REFERENCE TO RELATED APPLICATIONS

This application is a continuation in part of U.S. patent application Ser. No. 14/843,189, titled “System and Method for Reducing Salt Water Intrusion into an Aquifer” filed Sep. 2, 2015 which claims the benefit of U.S. Provisional Patent Application No. 62/167,468 titled “Method For Reducing Salt Water Intrusion Into a Fresh Water Aquifer” filed May 28, 2015, the content of both applications being incorporated in this disclosure by reference in their entireties.

### BACKGROUND

Groundwater withdrawal from aquifers beneath Southern California and other coastal communities has outstripped recharge from rainwater over the past many decades. As a result of this “water mining,” the water table has been drawn down to unprecedented levels—requiring ever-deeper and less productive water wells.

Along the coast, freshwater aquifers typically cross the shoreline at some depth where the water they carry traditionally discharges up through ocean floor and mixes with seawater—owing to the historically greater water pressure in the aquifer driven by mountain run-off rain water and subsequent percolation through the basin floor into the aquifers below.

With the increase of freshwater withdrawal from these aquifers, the freshwater pressure in the aquifers at the shoreline tends to drop—sometimes to the point where seawater percolates into freshwater aquifers at depth offshore and pushes onshore for some distance. The result is that water wells historically drilled close to the shoreline are “salted out” as the interface between fresh and salt waters (i.e., the pressure balance point) has steadfastly moved onshore.

FIG. 1 illustrates a typical fresh water system at a coastal location. Fresh water from rain and freshwater streams percolates into the soil and flows within an aquifer 1 from locations inland to below a coastal area 2 to below the ocean floor 3. If little fresh water is extracted from the aquifer 1, the water pressure within the aquifer 1 is often higher than the pressure at the ocean floor 3, so that no sea water percolates into the aquifer 1. In the fresh water system illustrated in FIG. 1, a salt/fresh water interface 22 is maintained downstream of first wells 4 located near the ocean 5.

However, as more and more fresh water is extracted from the aquifer 1 (in FIG. 1, from the first wells 4, from second wells 6 located further inland from the first wells 4 and from extraction field wells 7 located further inland from the second wells 6), the pressure within the aquifer 1 is reduced as the aquifer 1 approaches the coast. In the system illustrated in FIG. 1, the pressure within the aquifer 1 has been reduced sufficiently to allow seepage of sea water 8 into the aquifer 1 at the coast—which will soon shift the salt/fresh water interface 22 to upstream of first wells 4 and force the shutdown of the first wells 4. If the situation illustrated in FIG. 1 is allowed to continue, the seepage of sea water 8 will eventually contaminate more and more of the aquifer 1—forcing the eventual shutdown of the second wells 6 and much, if not all, of the extraction field wells 7.

Several methods have been proposed to combat this seawater intrusion into the onshore portion of these freshwater aquifers 1. One such method takes steps to increase the fresh water pressure in the aquifers 1 near the shoreline by injecting fresh water into water wells just inland from the salt/fresh water interface 22- to raise the pressure within the aquifer 1 sufficiently to meet or exceed the pressure of the sea water at the ocean floor 3. An obvious problem, however, with this method is the required depletion of existing fresh water reserves to the injection wells.

Another such method for combating the intrusion of salt water into aquifers is described in pending U.S. patent application Ser. No. 14/843,189. This method comprises the steps of: a) removing brackish water from the aquifer via a brackish water extraction well at a first distance from the ocean; b) introducing the removed brackish water into a desalination system to generate a first stream of water with a first salt content and a second stream of water having a second salt content, the first salt content being less than the second salt content and less than the salt content of the removed brackish water; and c) introducing at least a portion of the first stream of water into the aquifer via a barrier well at a second distance from the ocean, the second distance being greater than the first distance. One embodiment of a system for carrying out this method is illustrated in FIG. 2.

### SUMMARY

The present invention is a method and a system for controlling the intrusion of dissolved solids into a fresh water aquifer located proximate to an ocean, the aquifer comprising a downstream portion which is proximate to the ocean and has a first average dissolved solids (TDS) content, and an upstream portion which is distal to the ocean and has a second average TDS content, the first average TDS content being greater than the second average TDS content.

The method of the invention comprises the steps of: a) frequently measuring the TDS content at one or more control locations, each control location being defined within the aquifer between the downstream portion and the upstream portion, such frequent measuring of TDS content at the control location being conducted at least about once per calendar quarter, the frequent measuring of TDS content at the control location providing a plurality of control location TDS content values; b) comparing one or more of the plurality of control location TDS content values to a predetermined TDS control range; and c) adjusting the TDS content at the control location to within the predetermined TDS control range by one or more control measures.

The system of the invention comprises: a) a control water extraction well for removing water from a control location within the aquifer; b) a brackish water extraction well for removing water having a first TDS content from the aquifer at a location downstream of the control location; c) a low TDS water injection well for introducing water having a second TDS content water into the aquifer at a location upstream of the control location, the second TDS content being less than the first TDS content; d) brackish water extraction flow control means for controlling the extraction of brackish water via the brackish water extraction well; e) low TDS water injection flow control means for controlling the injection of low TDS water via the low TDS water injection well; and f) low TDS water injection TDS content control means for controlling the TDS content of the injection of low TDS water via the low TDS water injection well.

### DRAWINGS

These and other features, aspects and advantages of the present invention will become better understood with reference to the following description, appended claims, and accompanying drawings where:

FIG. 1 is a cross-sectional sketch of a coastal fresh water system of the prior art;

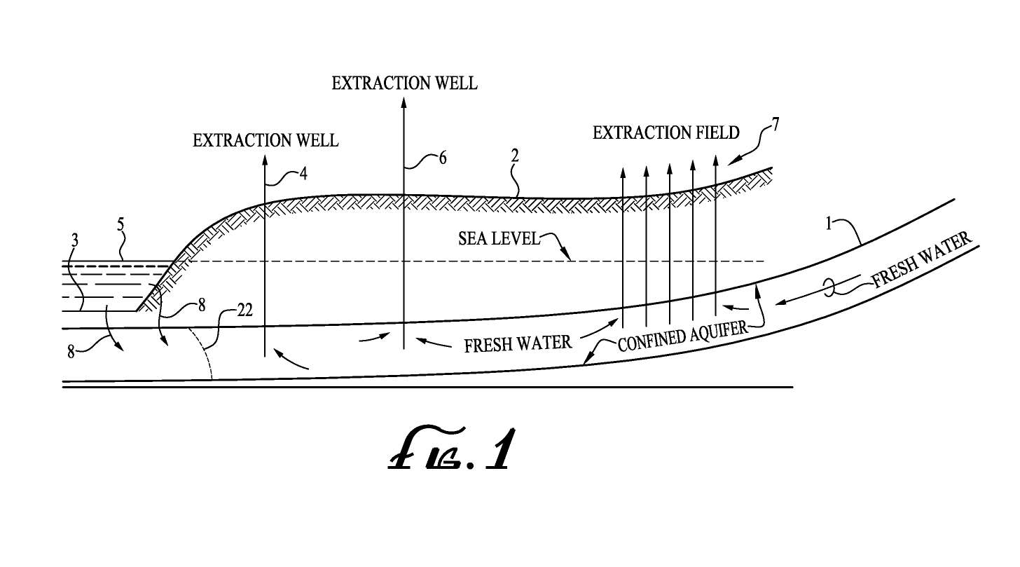

FIG. 2 is a cross-sectional sketch of the coastal fresh water system of FIG. 1, modified to provide a salt water intrusion reduction system of the type disclosed in U.S. patent application Ser. No. 14/843,189; and

FIG. 3 is a cross-sectional sketch of the coastal fresh water system of FIG. 2, modified to provide a control system for applying a method for controlling the intrusion of dissolved solids into a fresh water aquifer, the control system and the control method having features of the present invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

### DEFINITIONS

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

As used in this disclosure, the term “greywater” (also commonly spelled graywater, grey water, and gray water) is defined as waste water having a low contaminant content generated typically from domestic activities, such as showering, bathing, washing and laundry. “Greywater” does not include waste water having a high contaminate content, such as waste water generated from sewage and many industrial processes.

As used in this disclosure, the term “brackish water” is defined as water having a TDS (total dissolved solids) content of at least about 500 mg/L, but generally less than that of sea water. Brackish water can be described as low TDS brackish water (brackish water typically having a total dissolved solids content of at least about 1,000 mg/L TDS, but generally less 10,000 mg/L TDS) and high TDS brackish water (brackish water typically having a total dissolved solids content of at least about 10,000 mg/L TDS, but generally less than that of sea water).

### The Invention

In a first aspect, the invention is a control method for controlling the intrusion of dissolved solids into a fresh water aquifer located proximate to an ocean, the aquifer comprising a downstream portion which is proximate to the ocean and has a first average dissolved solids (TDS) content, and an upstream portion which is distal to the ocean and has a second average TDS content, the first average TDS content being greater than the second average TDS content. The control method comprises the steps of:

a) frequently measuring the TDS content at a control location, the control location being defined within the aquifer between the downstream portion and the upstream portion, such frequent measuring of TDS content at the control location being conducted at least about once per calendar quarter, the frequent measuring of TDS content at the control location providing a plurality of control location TDS content values;

b) comparing one or more of the plurality of control location TDS content values to a predetermined TDS control range; and

c) adjusting the TDS content at the control location to within the predetermined TDS control range by one or more control measures.

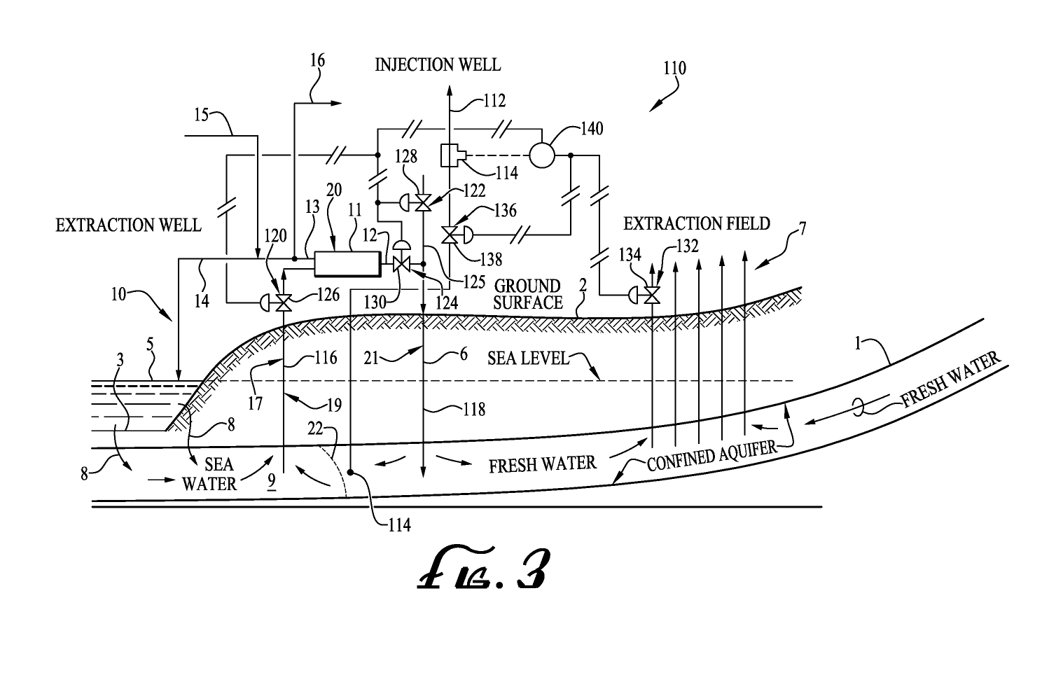

In a second aspect, the invention is a control system 110 for employing the control method of the invention. The control system 110 comprises: a) a control water extraction well 112 for removing water from a control location 114 within the aquifer 1; b) at least one brackish water extraction well 116 for removing water having a first TDS content from the aquifer 1 at a location downstream of the control location 114; c) at least one low TDS water injection well 118 for introducing water having a second TDS content water into the aquifer 1 at a location upstream of the control location 114, the second TDS content being less than the first TDS content; d) brackish water extraction flow control means 120 for controlling the extraction of brackish water via the at least one brackish water extraction well 116; e) low TDS water injection flow control means 122 for controlling the injection of low TDS water via the at least one low TDS water injection well 118; and f) low TDS water injection TDS content control means 124 for controlling the TDS content of the injection of low TDS water via the at least one low TDS water injection well 118. One embodiment of this aspect of the invention is illustrated in FIG. 3.

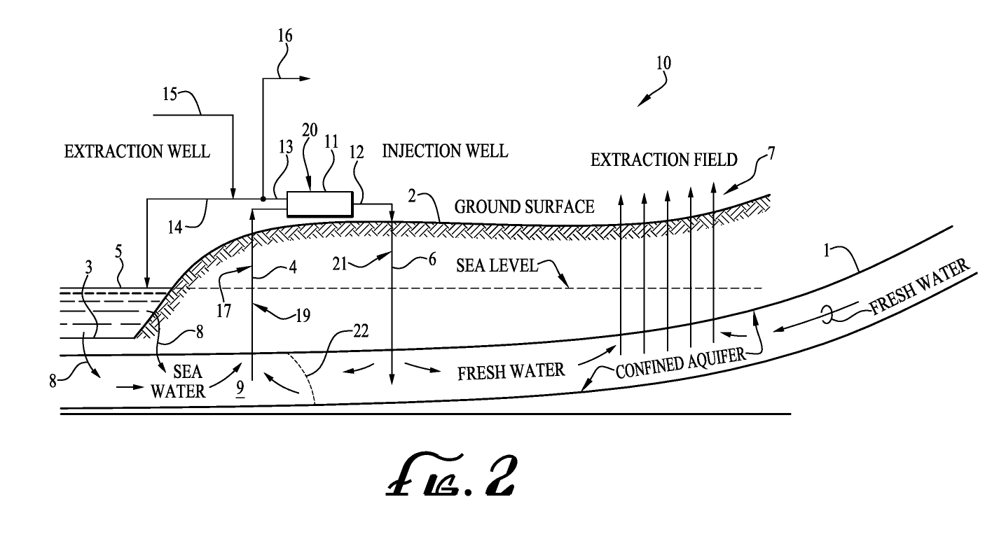

The embodiment illustrated in FIG. 3 illustrates how the control system of the invention 110 is applied to the salt water intrusion reduction system 10 illustrated in FIG. 2. As illustrated in FIGS. 2 and 3, the salt water intrusion reduction system 10 comprises: a) removal means 19 for removing brackish water 9 from the aquifer 1 at a first distance from the ocean 5; b) generating means 20 for generating a first stream of water 12 with a first salt content and a second stream of water 13 having a second salt content, the first salt content being less than the second salt content and less than the salt content of the removed brackish water 9; and c) introduction means 21 for introducing at least a portion of the first stream of water 12 into the aquifer 1 at a second distance from the ocean 5, the second distance being greater than the first distance.

The first distance is typically between about 0.5 miles and about 2 miles. The second distance is typically between about 2 miles and about 5 miles.

The salt water intrusion reduction system 10 can further comprise lines 14 to direct the second stream of water 13 into the ocean 5.

The salt water intrusion reduction system 10 can further comprising lines 15 for combining the second stream 13 with non-potable water to generate a combined stream which is introduction into the ocean 5, wherein the salt content of the combined stream is less than the salt content of the ocean 5.

In the salt water intrusion reduction system 10, the non-potable water can be grey water.

The salt water intrusion reduction system 10 can further comprise lines 16 to introduce the second stream of water 13 into an injection well of a petroleum field.

The salt water intrusion reduction system 10 can further comprise the removal of water from the second stream 13 to generate salt.

Typically in the salt water intrusion reduction system 10, the salt content of the brackish water 9 removed via the removal means 19 for removing brackish water 9 from the aquifer 1 is from about 500 mg/L to about 30,000 mg/L TDS, more typically from about 1,000 mg/L to about 20,000 mg/L TDS, still more typically from about 1,000 mg/L to about 5,000 mg/L TDS, such as from about 1,000 mg/L to about 2,000 mg/L TDS.

In one embodiment of the salt water intrusion reduction system 10, the removal means 19 for removing brackish water 9 from the aquifer 1 is provided by a brackish water extraction well 17, the generating means 20 for introducing the removed brackish water 9 into a desalination system is provided by a desalination system 11, and the introduction means 21 for introducing at least a portion of the first stream of water 12 into the aquifer 1 is provided by a barrier well 6. Thus, in this embodiment, the system comprises: a) a brackish water extraction well 17 for removing brackish water 9 from the aquifer 1 at a first distance from the ocean 5; b) a desalination system 11 for accepting the removed brackish water 9 from the brackish water extraction well 17 and generating a first stream of water 12 with a first salt content and a second stream of water 13 having a second salt content, the first salt content being less than the second salt content and less than the salt content of the removed brackish water 9; and c) the barrier well 6 for introducing at least a portion of the first stream of water 12 into the aquifer 1 at a second distance from the ocean 5, the second distance being greater than the first distance.

The brackish water extraction well 17 can be a newly drilled well or it can be a preexisting well.

The salt water intrusion reduction system 10 can be employed to carry out a salt water intrusion reduction method of reducing salt water intrusion into a fresh water aquifer 1. The salt water intrusion reduction method comprises the steps of: a) removing brackish water 9 from the aquifer 1 via an brackish water extraction well 17 at a first distance from the ocean 5; b) introducing the removed brackish water 9 into a desalination system 11 to generate a first stream of water 12 with a first salt content and a second stream of water 13 having a second salt content, the first salt content being less than the second salt content and less than the salt content of the removed brackish water 9; and c) introducing at least a portion of the first stream of water 12 into the aquifer 1 via a barrier well 6 at a second distance from the ocean 5, the second distance being greater than the first distance.

In the salt water intrusion reduction system 10 illustrated in FIG. 2, if first wells 4 do not exist at the site or are unusable, new wells can be drilled at a location more proximate to the ocean 5 than second wells 6 to provide the brackish water extraction wells 17.

The salt water intrusion reduction system 10 illustrated in FIG. 2 has the advantage of allowing the use of a plurality of small, often portable, desalination systems 11—rather than having to rely on a single massive fixed desalination system. Such small desalination systems 11 provide flexibility of operation, ease of maintenance, protection against system-wide desalination system shutdowns and marked reduction in environmental challenges. Small desalination systems 11 which can be used in the invention include, but are not limited to, Newterra EPRO 6000 SW, manufactured by Newterra of Lakeland, Fla., GE SeaTECH-252, manufactured by GE Power & Water of Trevose, Pa. and Desalitech ReFlex MAX 1200, manufactured by Desalitech of Newton, Mass.

As noted above, FIG. 3 illustrates how the salt water intrusion reduction system 10 can be modified to provide an embodiment of the control system 110 of the present invention and to carry out an embodiment of the control method of the present invention.

In the embodiment illustrated in FIG. 3, the at least one brackish water extraction well 116 is provided by the brackish water extraction well 17, the at least one low TDS water injection well 118 is provided by the barrier well 6, the brackish water extraction flow control means 120 is provided in part by brackish water extraction flow control valve 126, and the low TDS water injection flow control means 122 is provided in part by low TDS water injection control valve 128. Brackish water extraction wells 116 and low TDS water injection wells 118 can be existing wells or newly drilled wells.

The embodiment illustrated in FIG. 3 employs a desalination system 11 which generates a low TDS first stream of water 12 and the low TDS water injection TDS content control means 124 can be provided in part by (i) first stream of water control valve 130 which controls flow of low TDS water in the first stream of water 12 into the low TDS water injection well 118 and/or by (ii) the degree of desalination performed within the desalination system 11.

In the embodiment illustrated in FIG. 3, one or more fresh water extraction wells 7 are used to extract fresh water from upstream of the control location 114. In the embodiment illustrated in FIG. 3, the flow of water removed via the one or more fresh water extraction wells 7 can be controlled by fresh water extraction control means 132 and provided in part by fresh water extraction control valve 134.

Also in the embodiment illustrated in FIG. 3, the flow of water removed at the control location 114 is accomplished by the control water extraction well 112 controlled by control water extraction well control means 136 and provided by control water extraction well control valve 138.

In the embodiment illustrated in FIG. 3, each of the control valves 126, 128, 130, 134 and 138 can be controlled by one or more controllers 140. In other embodiments, some or all of the control valves 126, 128, 130,134 and 138 can be controlled by hand or by other suitable means. For example, an operator can travel to each site to adjust extraction rates and a groundwater manager can adjust injection rates from a control room.

Thus, in the control method of the invention, the one or more control measures for adjusting the TDS content at the control location 114 to within the predetermined TDS control range in step c) can include increasing or decreasing the rate of any water removal from the downstream portion of the aquifer 1 via the brackish water extraction wells 116. This can be accomplished using brackish water extraction flow control valve 126, operated in response to signal received from one or more controllers 140.

Control measures for adjusting the TDS content at the control location to within the predetermined TDS control range in step c) can also include decreasing or increasing the rate of any water removal from the control location 114 and/or from the upstream portion of the aquifer via extraction field wells 7. This can be accomplished using control water extraction well control valve 138 and/or fresh water extraction control valve 134, operated in response to signal received from the one or more controllers 140.

Control measures for adjusting the TDS content at the control location to within the predetermined TDS control range in step c) can also include increasing or decreasing the rate of any water addition having a TDS content less than the first average TDS to the upstream portion of the aquifer via injection wells 118. This can be accomplished by injecting low-TDS water into the injection wells 118 via upstream make-up water input line 125 having low TDS water injection control valves 128, operated in response to signal received from the one or more controllers 140.

Control measures for adjusting the TDS content at the control location to within the predetermined TDS control range in step c) can also include increasing or decreasing the TDS content of any water addition having a TDS content less than the first average TDS to the upstream portion of the aquifer via low TDS injection wells 118. This can be accomplished by increasing or decreasing the flow of makeup water having a low TDS via make-up water input line 125 having low TDS water injection control valves 128. In salt water intrusion reduction systems 10 having input from a first stream 12 of a desalination system 11, the TDS content of any water addition having a third average TDS content less than the first average TDS can be increased or decreased by controlling the flow of first desalination system of water via the first stream of water 12 control valve 130, operated in response to signal received from the one or more controllers 140. Also in salt water intrusion reduction systems 10 having input from a desalination system 11, the TDS content of any water addition having a TDS content less than the first average TDS can be increased or decreased by controlling the operation of the desalination system 11, itself.

In many areas, underground fresh water flows toward the ocean in multiple, generally parallel aquifers 1. A line of extraction wells for the several aquifers are therefore disposed in a line generally parallel to the coast. In such areas, another control measures for adjusting the TDS content at the control location to within the predetermined TDS control range in step c) is to vary the extraction and injection rates of the individual wells within the line as well as vary the extraction rates from, and injection rates into, any of the several aquifers that may be exposed in the individual wells within the line.

In all cases, when initially designing a control method of the invention, the transmissivity of the underlying aquifer must be taken into account. Initial injection and extraction rates must be estimated based on modeling of the aquifer and injection barrier of interest. Alternative scenarios need be tested to examine the implications of adding extraction wells of various sizes at target locations and to determine the optimal number, size and spacing.

Having thus described the invention, it should be apparent that numerous structural modifications and adaptations may be resorted to without departing from the scope and fair meaning of the instant invention as set forth herein above and described herein below by the claims.

What is claimed is:

1. A control method for controlling the intrusion of dissolved solids into a fresh water aquifer located proximate to an ocean, the aquifer comprising a downstream portion which is proximate to the ocean and has a first average dissolved solids (TDS) content, and an upstream portion which is distal to the ocean and has a second average TDS content, the first average TDS content being greater than the second average TDS content, the method comprising the steps of:
a) frequently measuring the TDS content at one or more control locations, each control location being defined within the aquifer between the downstream portion and the upstream portion, such frequent measuring of TDS content at the control location being conducted at least about once per calendar quarter, the frequent measuring of TDS content at the control location providing a plurality of control location TDS content values;
b) comparing one or more of the plurality of control location TDS content values to a predetermined TDS control range; and
c) adjusting the TDS content at the control location to within the predetermined TDS control range by one or more control measures.

2. The control method of claim 1 wherein the one or more control measures for adjusting the TDS content at the control location to within the predetermined TDS control range in step c) comprises one or more of the following control measures:
i) increasing the rate of any water removal from the downstream portion of the aquifer via withdrawal wells;
ii) decreasing the rate of any water removal from the downstream portion of the aquifer via withdrawal wells;
iii) increasing the rate of any water removal from the control location or from the upstream portion of the aquifer via withdrawal wells;
iv) decreasing the rate of any water removal from the control location or from the upstream portion of the aquifer via withdrawal wells;
v) increasing the rate of any water addition having a TDS content less than the first average TDS to the upstream portion of the aquifer via injection wells;
vi) decreasing the rate of any water addition having a TDS content less than the first average TDS to the upstream portion of the aquifer via injection wells;
vii) increasing the TDS content of any water addition having a TDS content less than the first average TDS to the upstream portion of the aquifer via injection wells; and/or
viii) decreasing the TDS content of any water addition having a TDS content less than the first average TDS to the upstream portion of the aquifer via injection wells.

3. A control system for reducing salt water intrusion into a fresh water aquifer comprising:
a) one or more control water extraction wells for removing water from a control location within the aquifer,
b) one or more brackish water extraction wells for removing water having a first TDS content from the aquifer at a location downstream of the control location;
c) one or more low TDS water injection wells for introducing water having a second TDS content water into the aquifer at a location upstream of the control location, the second TDS content being less than the first TDS content; and
d) brackish water extraction flow control means for controlling the extraction of brackish water via the one or more brackish water extraction wells.

4. The control system of claim 3 further comprising:
a) low TDS water injection flow control means for controlling the injection of low TDS water via the one or more low TDS water injection well; and
b) low TDS water injection TDS content control means for controlling the TDS content of the injection of low TDS water via the control water extraction well and/or the one or more low TDS water injection wells.

5. The control system of claim 3 further comprising:
a) one or more low TDS water extraction wells for removing water having a third TDS content from the aquifer at a location upstream of the control location, the third TDS content being less than the first TDS content; and
b) low TDS water extraction well flow control means for controlling the extraction of low TDS water via the one or more low TDS water extraction wells.

6. The control system of claim 3 further comprising a desalination system for accepting brackish water removed from one or more the brackish water extraction wells and generating a first stream of desalination system generated water with a fourth TDS content, the fourth TDS content being less than the first TDS content.
